(19) United States
(12) Patent Application Publication
(10) Pub. No.: US 2025/0314496 A1
(43) Pub. Date: Oct. 9, 2025

(54) APPARATUS AND METHOD FOR DETERMINING DIAGNOSTIC PATH AND FACILITY DIAGNOSTIC SYSTEM

(71) Applicant: Electronics and Telecommunications Research Institute, Daejeon (KR)

(72) Inventors: Hyun Yong LEE, Daejeon (KR); Jungi LEE, Daejeon (KR); Seok Kap KO, Daejeon (KR); Nack Woo KIM, Daejeon (KR); Yumin HWANG, Daejeon (KR)

(73) Assignee: Electronics and Telecommunications Research Institute, Daejeon (KR)

(21) Appl. No.: 19/090,843

(22) Filed: Mar. 26, 2025

(30) Foreign Application Priority Data
Apr. 3, 2024 (KR) 10-2024-0045312

(51) Int. Cl. G01C 21/20; G01N 23/20008

(52) U.S. Cl. CPC G01C 21/20; G01N 23/20008; G01N 2223/301

(57) ABSTRACT

Provided is an apparatus for determining a diagnostic path, the apparatus including: a communication module; and a processor, wherein the processor acquires an image related to a diagnostic target and captured by an unmanned aerial vehicle unit through the communication module, detects a region of interest (ROI) including an object of interest from the acquired image through an object recognition model, identifies a change in length of ROIs between a rotational image of the acquired image and the acquired images, and determines a flight direction of the unmanned aerial vehicle unit for photographing the object of interest based on the identified change in length.

### CROSS-REFERENCE TO RELATED APPLICATION

This application claims priority to and the benefit of Korean Patent Application No. 10-2024-0045312, filed on Apr. 3, 2024, the disclosure of which is incorporated herein by reference in its entirety.

### BACKGROUND

### 1. Field of the Invention

Various embodiments disclosed in this document relate to a facility diagnostic technique.

### 2. Discussion of Related Art

Facility systems require regular diagnosis of parts and the entirety thereof to ensure stable operation. However, diagnosing facility systems may be difficult due to the size, location, or facility characteristics. For example, solar power generation systems and wind power generation systems are installed in wide areas that are difficult to access, requiring significant time and effort for even a single diagnosis.

Recently, drones have been used to capture images of at least part of a facility system, providing diagnosis of the facility system based on the captured images.

### SUMMARY OF THE INVENTION

In drone-based facility diagnosis, it is very important to capture images such that a diagnosis part of a facility system is detectable. Typically, the diagnosis part of the facility system is not detected with a single capture, and it is required to control a drone flight such that the diagnosis part is effectively detected. To this end, the drone may detect the diagnosis part based on location information (e.g., Global Positioning System (GPS)) of the facility system. However, when the location information of the diagnosis part is missing or has changed, it may be difficult to detect the diagnosis part using the drone.

Various embodiments disclosed in this document may provide an apparatus and method for determining a diagnosis path with which it is possible to determine a flight path of an unmanned aerial vehicle to enable diagnosis of a target facility, and a facility diagnosis system.

According to an embodiment, an apparatus for determining a diagnostic path includes: a communication module; and a processor, wherein the processor acquires an image related to a diagnostic target and captured by an unmanned aerial vehicle unit through the communication module, detects a region of interest (ROI) including an object of interest from the acquired image through an object recognition model, identifies a change in length of ROIs between a rotational image of the acquired image and the acquired image, and determines a flight direction of the unmanned aerial vehicle unit for photographing the object of interest based on the identified change in length.

According to an embodiment, a method of determining a diagnostic path includes: acquiring an image related to a diagnostic target and captured by an unmanned aerial vehicle unit; detecting an ROI including an object of interest from the acquired image through an object recognition model; identifying a change in length of ROIs between a rotational image of the acquired image and the acquired image; and determining a flight direction of the unmanned aerial vehicle unit for photographing the object of interest based on the identified change in length.

According to an embodiment, a facility diagnostic system includes: a first unmanned aerial vehicle provided with an X-ray generator; a second unmanned aerial vehicle provided with an X-ray detector; a ground controller that controls the first unmanned aerial vehicle and the second unmanned aerial vehicle to fly and perform photographing to capture an X-ray image of an object of interest included in a target facility; and a server apparatus, wherein the server apparatus acquires an X-ray image which is based on emission of the X-ray generator and generated by the X-ray detector from the second aerial vehicle, detects an ROI including the object of interest from the acquired image through an object recognition model, identifies a change in length of ROIs between a rotational image of the acquired image and the acquired image, and determines a flight direction of the first aerial vehicle and the second aerial vehicle for photographing the object of interest based on the identified change in length.

### BRIEF DESCRIPTION OF THE DRAWINGS

The above and other objects, features and advantages of the present disclosure will become more apparent to those of ordinary skill in the art by describing exemplary embodiments thereof in detail with reference to the accompanying drawings, in which:

FIG. 1 is a block diagram of a facility diagnosis system according to an embodiment;

FIG. 2 is a block diagram of a server apparatus according to an embodiment;

FIG. 3 is an example of detecting a region of interest (ROI) based on an X-ray image according to an embodiment;

FIG. 4 is a first exemplary diagram of object direction determination according to an embodiment;

FIG. 5 is a second exemplary diagram of object direction determination according to an embodiment;

FIG. 6 is an example of detection data in a detection object database (DB) according to an embodiment;

FIGS. 7 and 8 show exemplary diagrams of flight direction determination using object path information according to an embodiment;

FIG. 9 is a diagram for describing a method of determining a flight direction when a direction of a detected object is not predicted according to an embodiment;

FIG. 10 is a diagram for describing a method of determining a flight direction when an object is not detected according to an embodiment;

FIG. 11 is a flowchart of a method of determining a detection path according to an embodiment;

FIG. 12 is a flowchart of a method of determining an object direction according to an embodiment; and

FIG. 13 is a flowchart of a method of determining a flight direction according to an embodiment.

In relation to the description of the drawings, identical or similar reference numerals may be used for identical or similar components.

### DETAILED DESCRIPTION OF EXEMPLARY EMBODIMENTS

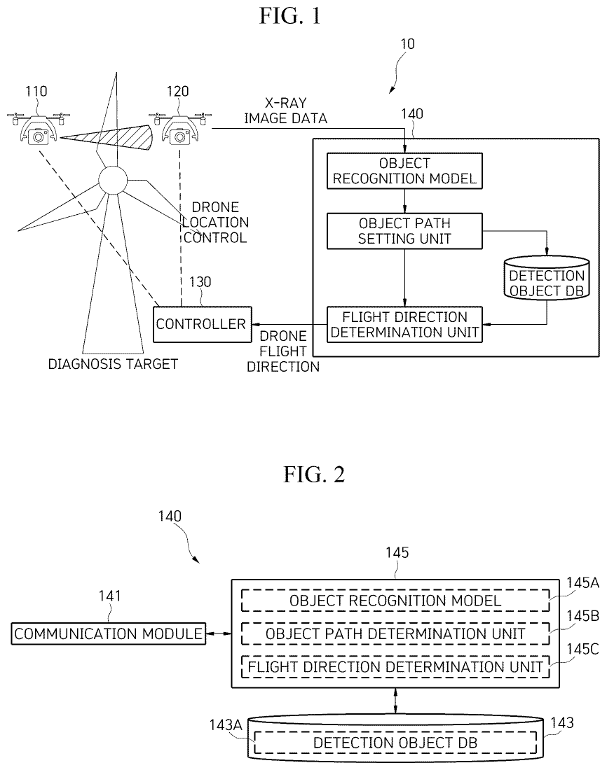

FIG. 1 is a block configuration diagram of a facility diagnosis system according to an embodiment.

Referring to FIG. 1, a facility diagnosis system 10 according to the embodiment may include a controller 130, unmanned aerial vehicle unit 110 and 120, and a server apparatus 140. In FIG. 1, an example in which a diagnosis target is a blade of a wind power generator (facility) is described. However, it is not limited thereto.

According to an embodiment, the controller 130 may be a device that controls the unmanned aerial vehicle unit 110 and 120 to fly and perform photographing. The controller 130 may be, for example, a drone ground control station. The controller 130 may control the flight of the unmanned aerial vehicle unit 110 and 120 by transmitting flight direction information according to a user's manipulation to the unmanned aerial vehicle unit 110 and 120. Alternatively, the controller 130 may control the flight of the unmanned aerial vehicle unit 110 and 120 by transmitting flight direction information from the server apparatus 140 to the unmanned aerial vehicle unit 110 and 120. The controller 130 may transmit a photographing command to the unmanned aerial vehicle unit 110 and 120 along with the flight direction information.

According to an embodiment, the unmanned aerial vehicle unit 110 and 120 may include a first unmanned aerial vehicle 110 and a second unmanned aerial vehicle 120. For example, the unmanned aerial vehicle unit 110 and 120 may be drones controlled manually and automatically by the controller 130. When the unmanned aerial vehicle unit 110 and 120 acquire the flight direction information and the photographing command from the controller 130, the unmanned aerial vehicle unit 110 and 120 may move to locations according to the flight direction information and capture an X-ray image of a diagnostic target.

According to an embodiment, the first unmanned aerial vehicle 110 and the second unmanned aerial vehicle 120 may be configured to capture images (e.g., X-ray images). For example, the first unmanned aerial vehicle 110 and the second unmanned aerial vehicle 120 may include an X-ray generator and an X-ray detector, respectively. The first unmanned aerial vehicle 110 may emit X-rays through the X-ray generator, and the second unmanned aerial vehicle 120 may detect X-rays emitted by the first unmanned aerial vehicle 110 through the X-ray detector.

According to an embodiment, the first unmanned aerial vehicle 110 and the second unmanned aerial vehicle 120 may capture X-ray images of a diagnostic target (or an object of interest in the diagnostic object) while flying in synchronization with each other with a diagnostic object therebetween. For example, the first unmanned aerial vehicle 110 may fly to emit X-rays toward the diagnostic target, and the second unmanned aerial vehicle 120 may fly to receive X-rays that have passed through the diagnostic target. The second unmanned aerial vehicle 120 may transmit the captured X-ray image to the server apparatus 140. Additionally or alternatively, the X-ray image may be transmitted to the server apparatus 140 via the controller 130.

According to an embodiment, the server apparatus 140 may determine the flight direction of the unmanned aerial vehicle unit 110 and 120 based on the X-ray image captured by the unmanned aerial vehicle unit 110 and 120.

The server apparatus 140 may acquire the image captured by the second unmanned aerial vehicle 120. When the server apparatus 140 acquires an X-ray image, the server apparatus 140 may detect a region of interest (ROI) including an object of interest related to the diagnosis target from the X-ray image through an object recognition model. The ROI may be, for example, a bounding box in which the object of interest is present. When the diagnosis target is a wind turbine, the object of interest may be a lightning cable installed inside the blade of the wind turbine.

The server apparatus 140 may identify a change in length of ROIs between a rotational image of the acquired image and the acquired image. The server apparatus 140 may determine the flight direction of the unmanned aerial vehicle unit 110 and 120 based on the identified change in length.

In addition, the server apparatus 140 may calculate probability values for detecting the object of interest from a plurality of flight direction candidates using an X-ray image sequence. The server apparatus 140 may determine the flight direction of the unmanned aerial vehicle unit 110 and 120 based on the calculated probability values. The X-ray image sequence may include a current X-ray image and at least one past X-ray image. Alternatively, the X-ray image sequence may not include a current X-ray image but may include only past X-ray images.

According to an embodiment, the server apparatus 140 may determine the flight direction of the unmanned aerial vehicle unit 110 and 120 based on at least one of the calculated probability values and/or the identified change in length. For example, when the identified change in length is outside a specified error range, the server apparatus 140 may determine the flight direction of the unmanned aerial vehicle unit 110 and 120 using a direction determined based on each of the calculated probability values and the identified change in length. The server apparatus 140 may determine the flight direction of the unmanned aerial vehicle unit 110 and 120 based on at least one of the median, the average, or the weighted average of a first rotation angle according to the calculated probability values and a second rotation angle according to the identified change in length, for example.

According to various embodiments, the server apparatus 140 may determine the flight direction of at least one unmanned aerial vehicle (e.g., 120) based on an image other than the X-ray image. In this case, the facility diagnosis system 10 may include a second unmanned aerial vehicle 120 provided with a camera or a LiDAR and may not include a first unmanned aerial vehicle 110.

According to various embodiments, the server apparatus 140 and the controller 130 may be provided as a single device.

As described above, the facility diagnosis system 10 according to the embodiment may determine and control the drone flight to diagnose the interior of the target facility using an X-ray image. For example, when an inverter diagnosis of a solar power generation system is required, the facility diagnosis system 10 may set a flight path to track the inverter instead of a solar panel and acquire related information, such as an image.

In addition, the facility diagnosis system 10 according to the embodiment may identify the location of an object of interest present inside the target facility using only an X-ray image of the target facility without additional information, such as latitude, longitude, and altitude information of the target facility, and may determine a drone flight path based on the identified location of the object of interest.

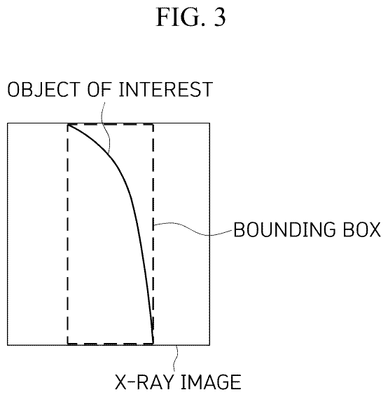

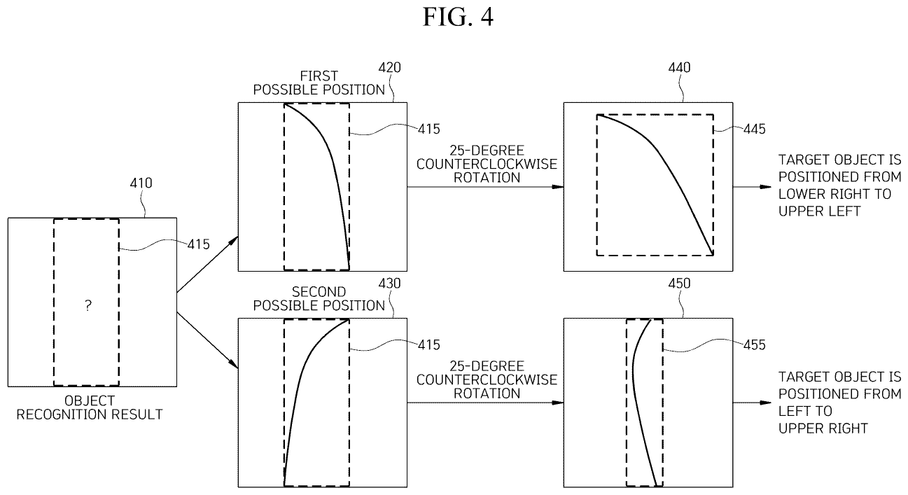

FIG. 2 is a block diagram of a server apparatus according to an embodiment, and FIG. 3 is an example of detecting an ROI based on an X-ray image according to an embodiment.

Referring to FIG. 2, a server apparatus 140 (an apparatus for determining a diagnosis path) according to the embodiment may include a communication module 141, a memory 143, and a processor 145. In an embodiment, in the server apparatus 140, some components may be omitted or additional components may be added. In addition, some of the components of the server apparatus 140 may be combined to form a single entity but may perform the same functions of the components before the combination.

The communication module 141 may support the establishment of a communication channel or a wireless communication channel between the server apparatus 140 and another apparatus (e.g., a controller 130 or unmanned aerial vehicle unit 110 and 120), and the performance of communication through the established communication channel. The communication channel may include, for example, at least one communication channel among a local area network (LAN), fiber to the home (FTTH), a digital subscriber line (xDSL), wireless broadband (WiBro), a wireless LAN, Wi-Fi, Bluetooth, ZigBee, Wi-Fi Direct (WFD), ultra-wideband (UWB), infrared communication (Infrared Data Association (IrDA)), Bluetooth Low Energy (BLE), near field communication (NFC), 3G, 4G, or 5G. The communication module 141 may communicate using known communication methods, such as code division multiple access (CDMA), Global System for Mobile Communications (GSM), W-CDMA, time division-synchronous code division multiple access (TD-SCDMA), WiBro, Long Term Evolution (LTE), and Evolved Packet Core (EPC).

The memory 143 may include various forms of volatile memories or nonvolatile memories. For example, the memory 143 may include a read only memory (ROM) and a random access memory (RAM). In an embodiment, the memory 143 may be located inside or outside the processor 145, and the memory 143 may be connected to the processor 145 through various known means. The memory 143 may store various types of data used by at least one component (e.g., the processor 145) of the server apparatus 140. The data may include, for example, input data or output data for software and instructions related thereto. For example, the memory 143 may store at least one instruction and data for determining a flight direction of an unmanned aerial vehicle (e.g., 120). The memory 143 may include a detection object DB 143A that stores X-ray images and detection object data including information generated by processing the X-ray images.

The processor 145 may control at least one other component (e.g., a hardware or software component) of the server apparatus 140 and perform various data processing processes or calculations. The processor 145 may include, for example, at least one of a central processing unit (CPU), a graphics processing unit (GPU), a microprocessor, an application processor, an application specific integrated circuit (ASIC), and a field programmable gate array (FPGA), and may have a plurality of cores. According to an embodiment, the processor 145 may include an object recognition model 145A, an object path determination unit 145B, and a flight direction determination unit 145C. The object recognition model 145A, the object path determination unit 145B, and the flight direction determination unit 145C may be software modules or hardware modules included in the processor 145. The object recognition model 145A, the object path determination unit 145B, and the flight direction determination unit 145C are included in the processor 145 or executed by the processor 145. Therefore, in the following document, for the sake of convenience of description, at least some operations of the object recognition model 145A, the object path determination unit 145B, and the flight direction determination unit 145C are described based on the processor 145.

According to an embodiment, the processor 145 may acquire an X-ray image captured by the unmanned aerial vehicle unit 110 and 120 through the communication module 141. For example, the processor 145 may acquire an X-ray image from the second unmanned aerial vehicle 120 directly or through the controller 130. In an embodiment, the processor 145 may acquire an X-ray image whenever the unmanned aerial vehicle unit 110 and 120 perform photographing.

According to an embodiment, the processor 145 may detect an ROI related to a diagnostic target from an X-ray image using an object recognition model 145A. For example, referring to FIG. 3, when the object recognition model 145A receives an X-ray image, the object recognition model 145A may recognize an object based on the X-ray image. The object recognition model 145A may output a region of an object of interest (hereinafter referred to as an “ROI”) representing the location of a detected object and a class of the detected object as a result of object recognition. The ROI may be, for example, a rectangular bounding box indicating a region in which an object of interest is present in the image.

According to an embodiment, the processor 145 may predict the direction in which the object of interest is connected (hereinafter referred to as the “object path (or object direction)”) based on the change in the length of the ROI using the object path determination unit 145B.

According to an embodiment, the object path determination unit 145B (or the processor 145) may generate a rotational X-ray image by rotating the X-ray image in a specified direction by a specified angle. For example, the object path determination unit 145B may generate a rotational image by rotating the original X-ray image clockwise or counterclockwise by a specified angle (e.g., in units of 25 degrees). The specified direction and the specified angle may be one or more values that are experimentally set.

The object path determination unit 145B may detect an ROI from the rotational X-ray image using the object recognition model 145A. The object path determination unit 145B may identify a change in length of the ROI of the rotational X-ray image compared to the original X-ray image. For example, the object path determination unit 145B may identify a change in the ratio of the horizontal length to the vertical length of the ROI (or changes in the horizontal length and the vertical length) in the original X-ray image and the rotational X-ray image. In this document, for the convenience of description, an example in which the object path determination unit 145B identifies the change in the ratio of the horizontal length to the vertical length of the ROI in the X-ray images is described. However, it is not limited thereto.

The object path determination unit 145B may predict an object direction corresponding to the change in the ROI identified based on specified reference information. The reference information may be, for example, information specified through learning/testing for the object direction (the direction in which the object of interest is connected) corresponding to the change in the ratio of the horizontal length to the vertical length and stored in the memory 143. For example, in a case in which the proportion of the horizontal length of the ROI in the X-ray image rotated counterclockwise increases, the object path determination unit 145B may predict the object direction as a diagonal direction extending from the lower right to the upper left. As another example, the object path determination unit 145B may predict the angle or orientation of the object direction based on the degree of change in the ratio of the horizontal length to the vertical length with respect to the center of the original X-ray image.

The object path determination unit 145B may generate and output object direction information corresponding to the predicted object direction. The object direction information may include information related to at least one of the rotation angle (e.g., 360 degrees) or a rotation orientation of the unmanned aerial vehicle with respect to the center of the X-ray image. The rotation orientation may be, for example, one direction according to an 8-direction system (e.g., east, west, south, north, northeast, southeast, northwest, southwest), a 16-direction system, or a 32-direction system.

According to an embodiment, the object path determination unit 145B may have difficulty detecting the object direction depending on the change in the ratio of the horizontal length to the vertical length of the ROI. For example, when the identified change in the ratio of the horizontal length to the vertical length of the ROI is within a specified error range, the object path determination unit 145B may have difficulty inferring the object direction from the change in the ratio because the change in the ratio is small between the original X-ray image and the rotational X-ray image. In this case, the object path determination unit 145B may generate “NULL” as the object direction information. The specified error range may be determined through an experiment for identifying an object direction based on X-ray images.

On the other hand, when the identified change in the ratio of the horizontal length to the vertical length of the ROI is outside the specified error range, the object path determination unit 145B may generate the object direction information determined based on the identified change in the ratio as described above.

According to an embodiment, the flight direction determination unit 145C may determine the flight direction of the unmanned aerial vehicle unit 110 and 120 by utilizing an X-ray image sequence including a current X-ray image. In this regard, the detection object DB 143A may store past detection data including past X-ray images, output information (ROI information) of the object recognition model 145A, output information (object direction information) of the object path determination unit 145B, and flight direction information determined by the flight direction determination unit 145C.

According to an embodiment, the flight direction determination unit 145C may calculate a probability value that an object of interest is present in a possible flight direction of the unmanned aerial vehicle unit 110 and 120 based on past detection data and current detection data. For example, the flight direction determination unit 145C may acquire past detection data related to a diagnosis target from the detection object DB 143A. The flight direction determination unit 145C may calculate a probability value that an object of interest is present based on trend information (e.g., an edge change of an image) of an object of interest, which includes an ROI (e.g., a feature value of the ROI), ROI information, and object direction information from the acquired past detection data, in an X-ray image.

According to an embodiment, the flight direction determination unit 145C may determine the flight direction of the current stage based on a deep learning model trained by inputting current detection data (an object direction determined from the current X-ray image) and past detection data (an object direction and flight direction information acquired from the previous X-ray image).

In an embodiment, the flight direction determination unit 145C may derive the flight direction based on the detection data through a deep learning-based artificial intelligence model or a related algorithm. For example, the flight direction determination unit 145C may include a flight direction detection model based on an artificial neural network technology, such as a long short-term memory (LSTM) or a transformer. For example, when detection data is input, the flight direction detection model may calculate probability values for each possible flight direction based on the feature value of the detection data.

In addition, the flight direction determination unit 145C may derive probability values for each flight direction by further using the Monte-Carlo dropout technique together with the flight direction detection model. When detection data is input, the Monte Carlo dropout technique may include, for example, calculating the uncertainty probability for the input detection data. The flight direction determination unit 145C may estimate the uncertainty of the flight direction detection model based on the calculated uncertainty probability and modify/supplement the flight direction detection model to improve the estimated uncertainty.

According to an embodiment, the flight direction determination unit 145C may determine at least one flight direction based on the calculated probability value. For example, the flight direction determination unit 145C may determine a specific number (e.g., 3) of prioritized flight directions in order of the highest probability value.

According to an embodiment, the flight direction determination unit 145C may determine the flight direction of the unmanned aerial vehicle unit 110 and 120 based on at least one of direction information among the object direction information from the object path determination unit 145B and the flight direction information determined by itself.

For example, the flight direction determination unit 145C may determine the flight direction of the unmanned aerial vehicle unit 110 and 120 based on an intermediate value (e.g., an average value) or a weighted average of a flight direction (e.g., a first rotation angle) determined based on the probability values and a flight direction (e.g., a second rotation angle) determined based on the identified ratio change.

As another example, the flight direction determination unit 145C may determine the flight direction of the current stage based on an algorithm that combines a currently determined object direction from a current X-ray image and an immediately preceding determined flight direction.

When the object of interest is located in the vertical (or up and down) direction of the ROI, it may be difficult to determine whether the direction of the previous object of interest is south or north. In this case, the flight direction determination unit 145C may compare the flight direction determined from the previous X-ray image with the currently determined flight direction and adjust the current flight direction of movement to an intermediate point between the compared directions. For example, in an 8-direction system, the object direction information determined from the current X-ray image (the result of processing by the object path determination unit 145B) is “west” and the flight direction information determined from the previous X-ray image (the result of processing by the flight direction determination unit 145C) is “north”. In this case, the “northwest” direction, which is a combination of the two pieces of direction information, may be determined to be the first priority, “west,” which is a result determined from the current X-ray image, may be determined to be the second priority, and “north,” which is a flight direction determined in the previous stage, may be determined to be the third priority. For another example, the object direction information determined from the current X-ray image is “northwest” and the flight direction information determined from the previous X-ray image is “north”. In this case, the flight direction determination unit 145C may combine the two pieces of direction information to calculate the “north-northwest” direction as the first priority, but it may also be replaced with “north.” As described above, the flight direction determination unit 145C according to the embodiment may comprehensively use the object direction and flight direction information determined based on the previous X-ray images and the object direction information determined from the current X-ray image to determine the next flight direction more accurately.

As another example, when the flight direction determination unit 145C fails to acquire object direction information from the object path determination unit 145B (when the change in the ratio of the horizontal length to the vertical length is within a specified error range), the flight direction determination unit 145C may determine the flight direction determined according to the probability values as the flight direction of the unmanned aerial vehicle unit 110 and 120. In this case, the flight direction determination unit 145C may determine the flight direction of the unmanned aerial vehicle unit 110 and 120 using the flight direction information determined based on the past X-ray images.

According to an embodiment, the flight direction determination unit 145C (or the processor 145) may generate determined flight direction information. The processor 145 may transmit the generated flight direction information to the controller 130 through the communication module 141. Thereafter, the controller 130 may transmit the flight direction information to the unmanned aerial vehicle unit 110 and 120 such that the unmanned aerial vehicle unit 110 and 120 additionally detect other parts of the object of interest. Since the unmanned aerial vehicle unit 110 and 120 include the first unmanned aerial vehicle 110 and the second unmanned aerial vehicle 120, the determined flight direction information may be generated such that the first unmanned aerial vehicle 110 and the second unmanned aerial vehicle 120 may move a certain distance toward the other part of the predicted object and capture an X-ray image. The flight direction information may be determined such that, for example, the first unmanned aerial vehicle 110 and the second unmanned aerial vehicle 120 may transmit and receive X-rays while the other part of the predicted object is interposed therebetween.

According to an embodiment, the processor 145 may store detection data including information generated while determining the flight direction based on X-ray images in the detection object DB 143A. The detection data may include, for example, output information (ROI information) of the object recognition model 145A, output information (object direction information) of the object path determination unit 145B, identification information for the diagnosis target (e.g., a facility ID), photographing identification information (e.g., a photographing ID) according to the photographing order, and image identification information assigned to each image.

According to an embodiment, the processor 145 may not detect an ROI based on the X-ray image. In this case, the processor 145 may determine that there is an error in the previous flight direction determination and provide the next-ranked flight direction information among a plurality of pieces of ranked flight direction information of the previous stage to the unmanned aerial vehicle unit 110 and 120.

In the above-described embodiment, the example in which the object path determination unit 145B performs a rotational transformation on the X-ray image has been described. However, alternatively, the processor 145 may further include a rotation transformation unit (not shown) and the X-ray image may be subjected to a rotational transformation by the rotation transformation unit (not shown).

As described above, the server apparatus 140 according to the embodiment may determine the flight direction of the unmanned aerial vehicle unit 110 and 120 for diagnosing the interior of the target facility using the X-ray image captured by the unmanned aerial vehicle unit 110 and 120 and provide the flight direction to the unmanned aerial vehicle unit 110 and 120.

In addition, the facility diagnosis system 10 according to an embodiment may identify the location of an object of interest present inside the target facility using only the X-ray image of the diagnosis target without additional information, such as latitude, longitude, and altitude information of the facility, and may determine the flight paths of the unmanned aerial vehicle unit 110 and 120 based on the location.

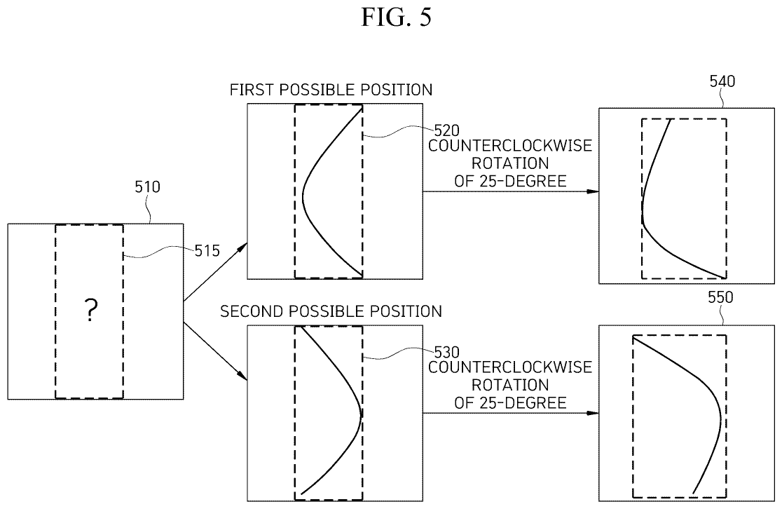

FIG. 4 is a first exemplary diagram of object direction determination according to an embodiment.

Referring to FIG. 4, as shown in a drawing 410, the object recognition model 145A may detect a first ROI 415 by recognizing an object of interest (see “?”) in the center portion of the original X-ray image.

The object of interest may be located in a first diagonal direction from the lower right to the upper left within the first ROI 415, as shown in a drawing 420, and may be located in a second diagonal direction from the lower left to the upper right within the first ROI 415, as shown in a drawing 430.

Thereafter, the object path determination unit 145B may generate a rotational X-ray image obtained by rotating the original X-ray image 25 degrees counterclockwise. The object path determination unit 145B may detect a second ROI 445 or 455 from the rotational X-ray image using the object recognition model 145A.

When an object of interest is located in the first diagonal direction as in the drawing 420, the horizontal length of the second ROI 445 detected from the rotational X-ray image as in the drawing 440 may be longer than that of the original X-ray image. Accordingly, in the horizontal length: vertical length ratio between the first ROI 415 and the second ROI 445, the proportion of the horizontal length may be increased. In this case, the object path determination unit 145B may determine that the object of interest is located in the first diagonal direction (from the lower right to the upper left). The object path determination unit 145B may generate object direction information corresponding to the first diagonal direction.

On the other hand, when the object of interest is located in the second diagonal direction as in the drawing 430, the the horizontal length of the second ROI 455 detected from the rotational X-ray image may be narrower than that of the original X-ray image as in the drawing 450. Accordingly, in the ratio of the horizontal length to the vertical length between the first ROI 415 and the second ROI 455, the proportion of the horizontal length may be reduced. In this case, the object path determination unit 145B may determine that the object of interest is located in the second diagonal direction (from the lower left to the upper right). The object path determination unit 145B may generate object direction information corresponding to the second diagonal direction.

According to various embodiments, the object path determination unit 145B may generate a plurality of rotational X-ray images and determine the object direction based on the plurality of rotational X-ray images. For example, the object path determination unit 145B may determine the object direction based on a first rotational X-ray image generated by 20-degree clockwise rotation and a second rotational X-ray image generated by 70-degree clockwise rotation.

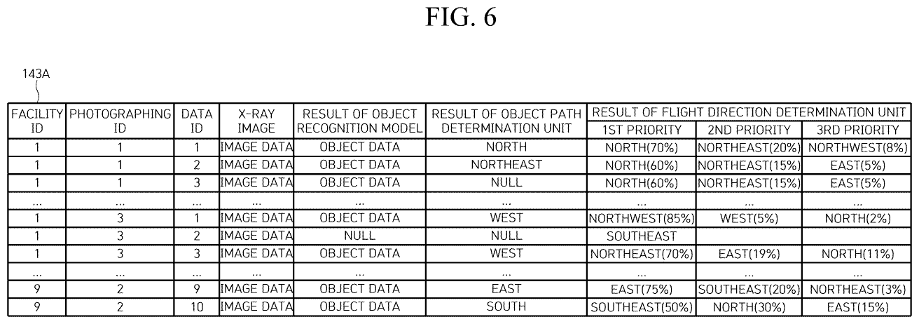

FIG. 5 is a second exemplary diagram of object direction determination according to an embodiment.

Referring to FIG. 5, as shown in a drawing 510, the object recognition model 145A may detect an ROI 515 by recognizing an object of interest (see “?”) in the center of the original X-ray image.

The object of interest may have a curvature similar to the letter “C,” as shown in a drawing 520, and may have a curvature close to left-right symmetry of the letter “C,” as shown in a drawing 530.

As shown in the drawings 540 and 550, in both cases in which the object of interest has a curvature of the letter “C” and a curvature symmetrical to the letter “C,” the change in the ratio of the horizontal length to the vertical length of the ROI of the rotational X-ray image may be within a specified error range. In this case, an object direction determined based on the ratio change by the object path determination unit 145B has a high possibility of error. Therefore, the object path determination unit 145B may not perform the object direction determination based on the ratio change and may generate object direction information including “NULL.” In this case, the server apparatus 140 may determine the flight direction based on the X-ray image sequence (e.g., including at least a part of the past detection data) through the flight direction determination unit 145C.

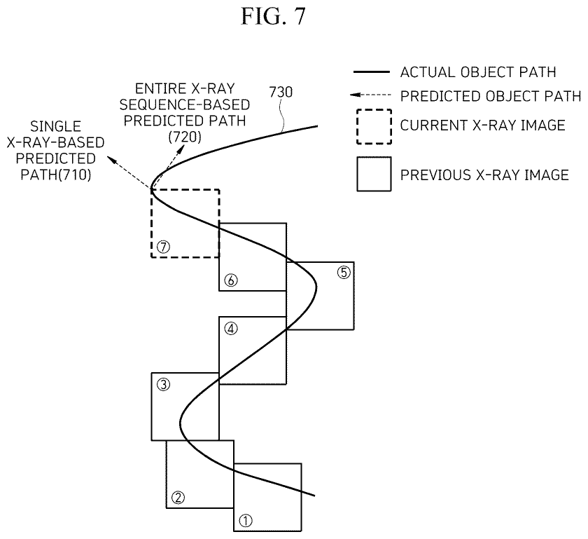

FIG. 6 is an example of detection data in a detection object DB according to an embodiment.

Referring to FIG. 6, the detection object DB 143A may include target identification information (a facility ID), photographing identification information (a photographing ID), data identification information (a data ID), an X-ray image (image data), object data (the “ROI information,” which is a processing result of the object recognition model), object direction information (a processing result of the object path determination unit), and flight direction information (a processing result of the flight direction determination unit). The target identification information may be a serial number assigned to each diagnosis object. The photographing identification information (a photographing ID) may be a serial number assigned sequentially according to the number of diagnoses performed on the diagnosis object. The data identification information (a data ID) may be a serial number assigned to detection data acquired with each diagnosis. The flight direction information may include, for example, a flight direction (e.g., north) of the unmanned aerial vehicle unit 110 and 120 and a probability value (e.g., 70%) of detection an object in each flight direction. The flight direction information may include a plurality of pieces of ranked flight direction information and probability values related thereto.

According to the above-described embodiment, the detection object DB 143A may store detection data by distinguishing the diagnosis targets and the number of times photographing is performed. Therefore, the server apparatus 140 may support selectively using past detection data corresponding to the same diagnosis target and the same number of times photographing is performed when detection the flight direction.

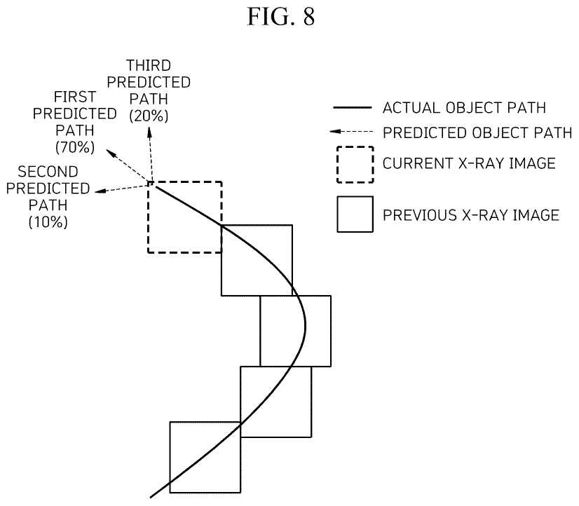

FIGS. 7 and 8 show exemplary diagrams of flight direction determination using object path information according to an embodiment.

Referring to FIG. 7, the server apparatus 140 may be in a process of determining the seventh flight direction after generating a total of six pieces of past detection data.

The server apparatus 140 may predict the upper left direction as the object direction 710 based on a single X-ray image \textcircled{7}. On the other hand, the server apparatus 140 may predict the upper right direction as the flight direction 720 using the entire X-ray image sequence including the past X-ray images \textcircled{7}, \textcircled{7}, \textcircled{7}, \textcircled{7}, \textcircled{7}, and \textcircled{7}.

In FIG. 7, it can be seen that the object direction (or the flight direction) detected using the entire X-ray image sequence is more similar to the actual object direction. As described above, when the object of interest is not in a diagonal shape (e.g., when it has a curved shape), the prediction of the object direction based on a single X-ray image may have low accuracy. However, the server apparatus 140 according to the embodiment may prepare for the low accuracy using the past X-ray image sequence.

Referring to FIG. 8, the flight direction determination unit 145C may determine three flight directions (e.g., predicted first to third paths) in order of the highest probability value (e.g., 10%, 20%, and 70%) among the flight direction candidates based on the past detection data and the current detection data. The flight direction determination unit 145C may determine the next flight direction based on the combined value (e.g., the intermediate value) of the flight direction with the highest probability value and the object path (direction) according to the object direction information. Additionally or alternatively, the server apparatus 140 may determine the combined values of each of the three flight directions and the object path (direction) as a plurality of flight directions, and provide the determined plurality of flight directions to the unmanned aerial vehicle unit 110 and 120.

According to one embodiment, the flight direction determination unit 145C may determine the flight direction of the current stage based on a deep learning model trained by inputting the current detection data (the object direction determined from the current X-ray image) and the past detection data (the object direction and the flight direction information obtained from the previous X-ray image).

According to an embodiment, the flight direction determination unit 145C may determine the flight direction of the current stage based on an algorithm that combines the currently determined object direction from the current X-ray image and the immediately preceding determined flight direction. When the object of interest is located in the vertical (or up and down) direction of the ROI, it may be difficult to determine whether the direction of the immediately previous object of interest is south or north.

To prevent such a difficulty, the flight direction determining unit 145C may compare the flight direction determined from the previous X-ray image with the currently determined flight direction and adjust the current flight direction to an intermediate point therebetween. For example, in the 8-direction system, the object direction information determined from the current X-ray image (the result of processing by the object path determination unit 145B) is “west” and the flight direction information determined from the previous X-ray image (the result of processing by the flight direction determination unit 145C) is “north”. In this case, the flight direction determining unit 145C may assign priorities to the directions as follow: first, the “northwest” direction, which is a combination of the two pieces of direction information; second, “west,” which is determined from the current X-ray image,, and third, “north,” which is a flight direction determined in the previous stage. As another example, when the object direction information determined from the current X-ray image is “northwest” and the flight direction information determined from the previous X-ray image is “north,” the flight direction determination unit 145C may combine the two pieces of direction information to calculate the “north-northwest” direction as the first priority, but it may also be replaced with “north.”

As described above, the flight direction determination unit 145C according to an embodiment may comprehensively use the object direction and flight direction information determined based on the previous X-ray images and the object direction information determined from the current X-ray image to determine the next flight direction more accurately.

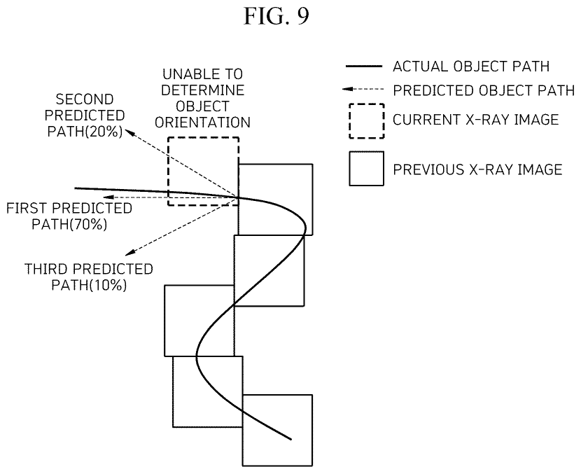

FIG. 9 is a diagram for describing a method of determining a flight direction when a direction of a detected object is not predicted according to an embodiment.

Referring to FIG. 9, the object path determination unit 145B may generate and output object direction information including NULL because the object path determination unit 145B is unable to determine the direction (the object direction) of the object of interest. In this case, the flight direction determination unit 145C of the server apparatus 140 may predict the object direction by utilizing past detection data generated from previous X-ray images and determine the flight direction based on the prediction result. In other words, the flight direction determination unit 145C may predict the next object direction based on past detection data generated from previous X-ray images and determine the flight direction based on the prediction result. As described above, the direction of an object included in an X-ray image is more likely to change gradually while maintaining the overall direction rather than changing abruptly, and the shape of the object is more likely to have a certain rule or pattern. Therefore, when the object direction is not predicted based on the current X-ray image, the object direction may be more accurately predicted by utilizing the past X-ray image sequence.

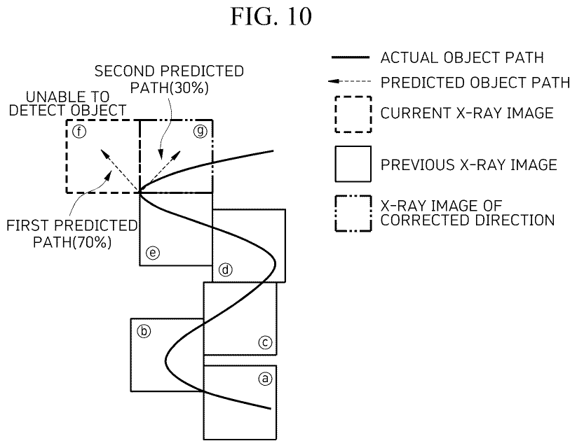

FIG. 10 is a diagram for describing a method of determining a flight direction when an object is not detected according to an embodiment.

Referring to FIG. 10, the server apparatus 140 may not detect the object from the current X-ray image transmitted from the unmanned aerial vehicle unit 110 and 120. This may be because the flight direction determined in the previous stage is wrong, resulting in an object not being detected in the X-ray image. Accordingly, the server apparatus 140 may provide the first and second unmanned aerial vehicle 110, 120 with previously determined next-ranked flight direction information from the unmanned aerial vehicle unit 110 and 120. In this case, the server apparatus 140 may delete the flight direction information of the previous detection data, in which no object is detected, from the detection object DB 143A, thereby increasing the accuracy of the detection data.

Thereafter, the unmanned aerial vehicle unit 110 and 120 may move according to the next-ranked flight direction and then capture and transmit an X-ray image of the diagnosis target.

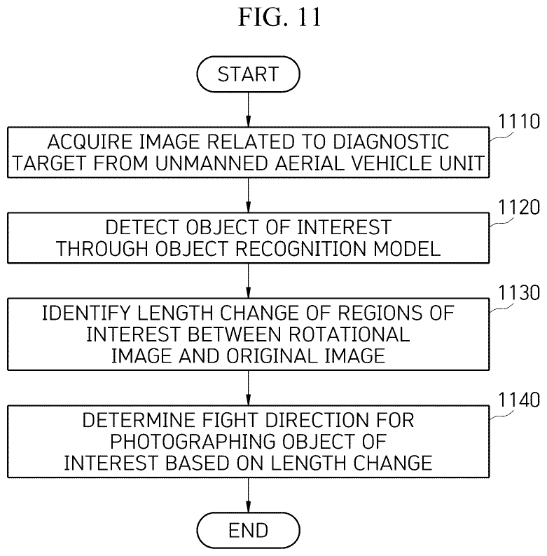

FIG. 11 is a flowchart of a method of determining a detection path according to an embodiment.

Referring to FIG. 11, in operation 1110, the server apparatus 140 may acquire an image related to a diagnostic target and captured by the unmanned aerial vehicle unit 110 and 120.

In operation 1120, the server apparatus 140 may detect an ROI including an object of interest from the acquired image through the object recognition model 145A.

In operation 1130, the server apparatus 140 may identify a change in length of ROIs between a rotational image of the acquired image and the acquired image

In operation 1140, the server apparatus 140 may determine a flight direction of the unmanned aerial vehicle unit for photographing the object of interest based on the identified change in length.

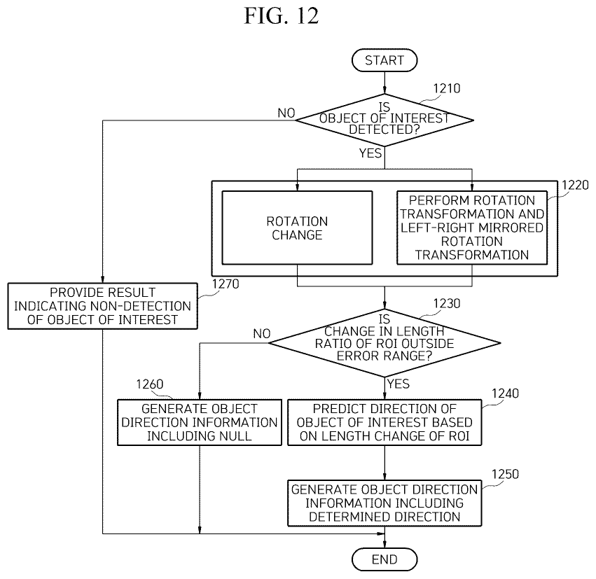

FIG. 12 is a flowchart of a method of determining an object direction according to an embodiment.

Referring to FIG. 12, in operation 1210, the server apparatus 140 (e.g., the object recognition model 145A) may detect an object of interest from an X-ray image.

In operation 1220, the server apparatus 140 (e.g., the object path determination unit 145B) may, upon detecting an object of interest, generate a first rotational image and a second rotational image by performing a first rotation transformation and a second rotation transformation on the X-ray image.

In operation 1230, the server apparatus 140 may identify a change in a ratio of a horizontal length to a vertical length of the ROI in the first rotational image and the second rotational image compared to the ROI of the original X-ray image. The server apparatus 140 may identify whether the ratio change corresponding to each rotational image is outside a specified error range.

When it is identified in operation 1230 that the ratio change corresponding to each rotational image is outside the specified error range, the server apparatus 140 may predict a direction corresponding to the ratio change as an object direction in operation 1240.

In operation 1250, the server apparatus 140 may generate object direction information including the predicted object direction.

When it is identified in operation 1230 that the ratio change corresponding to each rotational image is within the specified error range, the server apparatus 140 may generate object direction information including Null without determining the object direction based on the ratio change in operation 1260.

When no object of interest is detected in the X-ray image in operation 1210, the server apparatus 140 (the object recognition model 145A) may generate object recognition information (e.g., ROI information) indicating object non-detection in operation 1270. In the above-described embodiment, the object recognition information and the object direction information may be stored in the detection object DB 143A and used by the flight direction determination unit 145C.

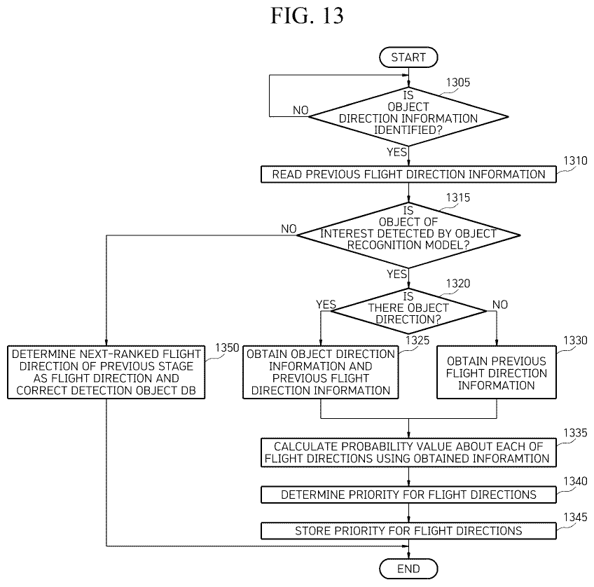

FIG. 13 is a flowchart of a method of determining a flight direction according to an embodiment.

Referring to FIG. 13, when it is identified in operation 1305 that object direction information is generated, the flight direction determination unit 145C may retrieve previous flight direction information from the detection object DB 143A in operation 1310. In operation 1305, the flight direction determination unit 145C may identify ROI information.

In operation 1315, the flight direction determination unit 145C may identify whether an object of interest is detected from the current X-ray image. For example, the flight direction determination unit 145C may identify whether the object of interest is detected from location information or class information of the ROI information.

In operation 1320, the flight direction determination unit 145C identifies whether there is an object direction included in the object direction information.

When it is identified in operation 1320 that there is an object direction included in the object direction information, the flight direction determination unit 145C may determine the object direction information and the previous flight direction information as information to be used for detecting the flight direction in operation 1325.

When it is identified in operation 1320 that there is no object direction included in the object direction information (when the object direction information includes Null), the flight direction determination unit 145C may determine the previous flight direction information as information to be used for detecting the flight direction in operation 1330.

In operation 1335, the flight direction determination unit 145C may input the object direction information and the previous flight direction information and/or the previous flight direction information into the flight direction detection model to calculate probability values for detecting an object in each flight direction.

In operation 1340, the flight direction determination unit 145C may determine the priority for the determined flight directions. In operation 1345, the priority-ranked flight directions may be stored. The flight direction determination unit 145C may determine the flight direction of the highest priority as the flight direction of the unmanned aerial vehicle unit 110 and 120.

When it is identified in operation 1315 that no object of interest is detected from the current X-ray image, the flight direction determination unit 145C may determine the next-ranked flight direction of the previous stage as the flight direction in operation 1350. The flight direction determination unit 145C may delete the flight direction information determined in the previous stage, in which no object of interest is detected, from the detection object DB 143A.

The various embodiments of the disclosure and terminology used herein are not intended to limit the technical features of the disclosure to the specific embodiments, but rather should be understood to cover all modifications, equivalents, and alternatives falling within the spirit and scope of the invention. Like numbers refer to like elements throughout the description of the drawings. The singular forms preceded by “a” and “an” corresponding to an item are intended to include the plural forms as well unless the context clearly indicates otherwise. In the disclosure, a phrase such as “A or B,” “at least one of A and B,” “at least one of A or B,” “A, B or C,” “at least one of A, B and C,” and “at least one of A, B, or C” may include any one of the items listed together in the corresponding phrase, or any possible combination thereof. Terms such as “first,” “second,” etc. are used to distinguish one element from another and do not modify the elements in other aspects (e.g., importance or sequence). When one (e.g., a first) element is referred to as being “coupled” or “connected” to another (e.g., a second) element with or without the term “functionally” or “communicatively,” it means that the one element is connected to the other element directly (e.g., by wire), wirelessly, or via a third element.

As used herein, the term “module” may include units implemented in hardware, software, or firmware, and may be interchangeably used with terms such as “logic,” “logic block,” “component,” or “circuit.” The module may be an integrally configured component or a minimum unit or part of the integrally configured component that performs one or more functions. For example, according to one embodiment, the module may be implemented in the form of an application-specific integrated circuit (ASIC).

The various embodiments of the present disclosure may be realized by software (e.g., a program) including one or more instructions stored in a storage medium (e.g., an internal memory or external memory,) that can be read by a machine (e.g., a server apparatus). For example, a processor (e.g., the processor 145) of the machine (e.g., the server apparatus 140) may invoke and execute at least one instruction among the stored one or more instructions from the storage medium. Accordingly, the machine operates to perform at least one function in accordance with the invoked at least one command. The one or more instructions may include code generated by a compiler or code executable by an interpreter. The machine-readable storage medium may be provided in the form of a non-transitory storage medium. Here, when a storage medium is referred to as “non-transitory,” it can be understood that the storage medium is tangible and does not include a signal (for example, electromagnetic waves), but rather that data is semi-permanently or temporarily stored in the storage medium.

According to one embodiment, the methods according to the various embodiments disclosed herein may be provided in a computer program product. The computer program product may be traded between a seller and a buyer as a product. The computer program product may be distributed in the form of a machine-readable storage medium (e.g., a compact disc read only memory (CD-ROM)) or may be distributed directly between two user devices (e.g., smartphones) through an application store (e.g., Play Store™), or online (e.g., downloaded or uploaded). In the case of online distribution, at least a portion of the computer program product may be stored at least semi-permanently or may be temporarily generated in a machine-readable storage medium, such as a memory of a server of a manufacturer, a server of an application store, or a relay server.

Components according to various embodiments of the disclosure may be implemented in the form of software or hardware, such as a digital signal processor (DSP), an FPGA or an ASIC, and may perform predetermined functions. The term “elements” is not limited to meaning software or hardware. Each of the elements may be configured to be stored in a storage medium capable of being addressed and configured to execute one or more processors. For example, the elements may include elements such as software elements, object-oriented software elements, class elements, and task elements, processes, functions, attributes, procedures, subroutines, segments of program code, drivers, firmware, microcode, circuits, data, databases, data structures, tables, arrays, and variables.

According to the various embodiments, each of the above-described elements (e.g., a module or a program) may include a singular entity or a plurality of entities. According to various embodiments, one or more of the above-described elements or operations may be omitted, or one or more other elements or operations may be added. Alternatively, or additionally, a plurality of elements (e.g., modules or programs) may be integrated into one element. In this case, the integrated element may perform one or more functions of each of the plurality of elements in a manner the same as or similar to that performed by the corresponding element of the plurality of components before the integration. According to various embodiments, operations performed by a module, program, or other elements may be executed sequentially, in parallel, repeatedly, or heuristically, or one or more of the operations may be executed in a different order, or omitted, or one or more other operations may be added.

According to various embodiments disclosed in this document, a flight path of an unmanned aerial vehicle can be determined to enable diagnosis of a target facility. In addition, various effects that may be directly or indirectly identified through this document can be provided.

What is claimed is:

1. An apparatus for determining a diagnostic path, the apparatus comprising:
a communication module; and
a processor,
wherein the processor is configured to:
acquire an image related to a diagnostic target and captured by an unmanned aerial vehicle unit through the communication module;
detect a region of interest (ROI) including an object of interest from the acquired image through an object recognition model;
identify a change in length of ROIs between a rotational image of the acquired image and the acquired image; and
determine a flight direction of the unmanned aerial vehicle unit for photographing the object of interest based on the identified change in length.

2. The apparatus of claim 1, wherein the unmanned aerial vehicle unit comprises a first unmanned aerial vehicle and a second unmanned aerial vehicle, and
the acquired image is an X-ray image generated based on X-rays emitted from the first unmanned aerial vehicle, which are received by the second unmanned aerial vehicle after passing through the diagnostic target.

3. The apparatus of claim 2, wherein the processor determines the flight direction such that the first unmanned aerial vehicle and the second unmanned aerial vehicle transmit and receive the X-rays for a portion in which the object of interest is connected using the acquired image.

4. The apparatus of claim 1, wherein the processor is configured to:
rotate the acquired image clockwise or counterclockwise by a specified angle to generate a rotational image;
detect a region of the object of interest from the rotational image through the object recognition model; and
determine the flight direction corresponding to a change in a ratio of a horizontal length to a vertical length of the ROIs between the rotational image and the acquired image.

5. The apparatus of claim 4, wherein the processor determines an angle or orientation of the flight direction based on a center of the acquired image based on a degree of the change in the ratio of the horizontal length to the vertical length.

6. The apparatus of claim 1, wherein the processor calculates probability values for detecting the object of interest from a plurality of flight direction candidate groups using the acquired image and at least one past image related to the diagnosis object, and
determines the flight direction based on at least one variable among the calculated probability values and the identified change in length.

7. The apparatus of claim 6, further comprising a detection object DB that stores object identification information of the diagnosis object, photographing identification information according to a photographing order, and image identification information assigned to each image, and the past images to be associated with each other, and
the processor uses at least one past image among the past images in which the object identification information is the same and the photographing identification information is the same or closest to the diagnosis target to calculate the probability values.

8. The apparatus of claim 6, wherein the processor, when the identified change in length is outside a specified error range, determines the flight direction based on the calculated probability values and the change in length.

9. The apparatus of claim 8, wherein the processor determines the flight direction of the unmanned aerial vehicle unit based on an intermediate value or an average value of a first rotation angle according to the calculated probability values and a second rotation angle according to the identified change in length.

10. The apparatus of claim 6, wherein the processor, when the identified change in length is within the specified error range, recalculates probability values for detecting the object of interest using the past images, and determines the flight direction based on the recalculated probability values.

11. The apparatus of claim 6, wherein the processor, when the ROI is undetectable based on the acquired image, provides a next-ranked flight direction among a plurality of previously determined ranked flight directions to the unmanned aerial vehicle unit through the communication module.

12. A method of determining a diagnostic path, the method comprising:
acquiring an image related to a diagnostic target and captured by an unmanned aerial vehicle unit;
detecting a region of interest (ROI) including an object of interest from the acquired image through an object recognition model;
identifying a change in length of ROIs between a rotational image of the acquired image and the acquired image; and
determining a flight direction of the unmanned aerial vehicle unit for photographing the object of interest based on the identified change in length.

13. The method of claim 12, wherein the unmanned aerial vehicle unit comprises a first unmanned aerial vehicle and a second unmanned aerial vehicle, and the acquired image is an X-ray image generated based on X-rays emitted from the first unmanned aerial vehicle, which are received by the second unmanned aerial vehicle after passing through the diagnostic target, and
the determining includes determining the flight direction such that the first unmanned aerial vehicle and the second unmanned aerial vehicle transmit and receive the X-rays for a portion in which the object of interest is connected using the acquired image.

14. The method of claim 12, wherein the identifying includes identifying a change in a ratio of a horizontal length to a vertical length of the ROIs between the rotational image and the acquired image.

15. The method of claim 12, wherein the determining includes calculating probability values for detecting the object of interest from a plurality of flight direction candidate groups using the acquired image and at least one past image related to the diagnosis object, and
determining the flight direction based on at least one variable among the calculated probability values and the identified change in length.

16. The method of claim 12, wherein the determining includes identifying whether the identified change in length is outside a specified error range, and
when the identified change in length is outside the specified error range, determining the flight direction based on a combined value of a first rotation angle according to the calculated probability values and a second rotation angle according to the identified change in length.

17. The method of claim 12, wherein the determining includes identifying whether the identified change in length is outside a specified error range, and
when the identified change in length is within the specified error range, recalculating probability values for detecting the object of interest using the past images and determining the flight direction based on the recalculated probability values.

18. The method of claim 12, further comprising, when the ROI is undetectable based on the acquired image, providing a next-ranked flight direction among a plurality of previously determined ranked flight directions to the unmanned aerial vehicle unit.

19. A facility diagnostic system comprising:
a first unmanned aerial vehicle provided with an X-ray generator;
a second unmanned aerial vehicle provided with an X-ray detector;
a ground controller that controls the first unmanned aerial vehicle and the second unmanned aerial vehicle to fly and perform photographing to capture an X-ray image of an object of interest included in a target facility; and
a server apparatus,
wherein the server apparatus is configured to:
acquire the X-ray image which is based on emission of the X-ray generator and generated by the X-ray detector from the second unmanned aerial vehicle;
detect a region of interest (ROI) including the object of interest from the acquired image through an object recognition model;
identify a change in length of ROIs between a rotational image of the acquired image and the acquired image; and
determine a flight direction of the first unmanned aerial vehicle and the second unmanned aerial vehicle for photographing the object of interest based on the identified change in length.

20. The facility diagnostic system of claim 19, wherein the server apparatus identifies a change in a ratio of a horizontal length to a vertical length of the ROIs between the rotational image and the acquired image and determines the flight direction corresponding to the change in the ratio.
